(19) United States
(12) Patent Application Publication
(10) Pub. No.: US 2021/0018335 A1
(43) Pub. Date: Jan. 21, 2021

(54) UTILITY MONITORING AND ANALYTICS SECURITY MANAGEMENT SYSTEM AND METHOD

(71) Applicant: Verdafero, Inc., San Jose, CA (US)

(72) Inventor: Alastair Hood, San Jose, CA (US)

(21) Appl. No.: 16/671,114

(22) Filed: Oct. 31, 2019

Related U.S. Application Data
(63) Continuation-in-part of application No. 13/548,089, filed on Jul. 12, 2012, now Pat. No. 10,535,022.
(60) Provisional application No. 61/507,569, filed on Jul. 13, 2011.

(51) Int. Cl. G01D 4/00; G06Q 50/06; G06Q 50/16

(52) U.S. Cl. CPC G01D 4/004; G06Q 50/163; G06Q 50/06

(57) ABSTRACT

A utility monitoring and analytics security management and method for businesses provides these businesses with a comprehensive understanding of their utility security strategy goals, utility security projects, and security metrics including the environmental and societal impacts of their business with the ability to manage and report on these parameters in a way that makes sense for the security of their business.

### RELATED APPLICATIONS

This application is a continuation in part and claims priority under 35 USC 120 to U.S. application Ser. No. 13/548,089, filed Jul. 12, 2012 which in turn claims the benefit under 35 USC 119(e) to U.S. Provisional Patent Application Ser. No. 61/507,569, filed on Jul. 13, 2011 and entitled “Utility Monitoring and Analytics Security Management System and Method”, the entirety of both of which are incorporated herein by reference.

### FIELD

The disclosure relates generally to a system and method for monitoring and analyzing a building's utilities and in particular to a system and method for providing analytical insight into the utility data as part of a business' security strategy.

### BACKGROUND

It is desirable to be able to monitor all utility usage and cost of a business to detect any undesired usage or cost variations. Today, the most prevalent system is the widespread attempted use of an individual person tracking their utility costs and usage in spreadsheets and email, presentations and documents to display and report their usage and costs findings to identify security factors or variations that may need further investigation. This technique is prone to errors and misunderstanding and can quickly become complicated and unmanageable.

Thus, it is desirable to provide a utility monitoring and analytics security management system and method that overcomes the limitations of current methods above, and it is to this end that the disclosure is directed.

### BRIEF DESCRIPTION OF THE DRAWINGS

FIG. 1 is a block diagram of an implementation of the utility monitoring and analytics security management system;

FIG. 2 is a flowchart of a method for utility monitoring and analytics security management using, for example, the system in FIG. 1;

FIGS. 3A and 3B illustrate examples of the output data of the utility monitoring and analytics security management system;

FIG. 4 is a flowchart illustrating more details of a method for utility monitoring and analytics security management using, for example, the system in FIG. 1;

FIG. 5 is a flowchart illustrating the potential options available for a method for utility monitoring and analytics security management using, for example, the system in FIG. 1;

FIG. 6 is a flowchart asking the user for input on what utilities they would like to monitor;

FIG. 7 illustrates an example of an improving the performance of your building utility security analysis summary user interface of the utility monitoring and analytics security management system;

FIG. 8 illustrates an example of a system to provide a utility overview report from an analysis with the utility monitoring and analytics security management system;

FIG. 9 illustrates an example of a system to check your utility bills for errors using the utility monitoring and analytics security management system;

FIG. 10 illustrates an example of a system to detect unusual behavior of your building utility security usage and costs using the utility monitoring and analytics security management system;

FIG. 11 illustrates an example of comparing your property against others/your own utility usage user interfaces of the utility monitoring and analytics security management system;

FIG. 12 illustrates an example of setting utility security goals/develop utility monitoring security plan user interfaces of the utility monitoring and analytics security management system;

FIG. 13 illustrates an example of a utility security monitoring certification checklist summary user interface of the utility monitoring and analytics security management system;

FIG. 14 illustrates an example of a building performance for insurance/financial assessment report user interface of the utility monitoring and analytics security management system;

FIG. 15 illustrates an example of a local governmental building ordinances report user interface of the utility monitoring and analytics security management system;

FIG. 16 illustrates an example of identifying fraudulent/suspicious activity using machine learning/AI user interface of the utility monitoring and analytics security management system;

FIG. 17 illustrates an example of quantative data capture of the utility monitoring and analytics security management system;

FIG. 18 illustrates an example of data analysis process of the utility monitoring and analytics security management system;

FIG. 19 illustrates an example of data output process of the utility monitoring and analytics security management system;

FIG. 20 illustrates an example of the utility monitoring report process of the utility monitoring and analytics security management system;

FIG. 21 illustrates an example of the utility analysis report process of the utility monitoring and analytics security management system;

FIG. 22 illustrates an example of the abnormalities/potential security problems report process of the utility monitoring and analytics security management system;

FIG. 23 illustrates an example of the property utility comparison report process of the utility monitoring and analytics security management system;

FIG. 24 illustrates an example of the utility security monitoring certification report process of the utility monitoring and analytics security management system;

FIG. 25 illustrates an example of the property performance for insurance report process of the utility monitoring and analytics security management system;

FIG. 26 illustrates an example of the local governmental building ordinance reporting process of the utility monitoring and analytics security management system;

FIG. 27 illustrates an example of the machine learning/AI detected fraudulent/suspicious activity report process of the utility monitoring and analytics security management system; and

FIGS. 28A-28B illustrate an example of a company main utility monitoring dashboard user interface of the utility monitoring and analytics security management system.

### DETAILED DESCRIPTION OF ONE OR MORE EMBODIMENTS

The disclosure is particularly applicable to a web-based system that implements the Utility Monitoring and Analytics Security Management System and Method, and it is in this context that the disclosure will be described. It will be appreciated, however, that the system and method has greater utility since it can be implemented in other manners/using different architectures, and may be used for other purposes that those specifically described below for the specific implementation.

A Utility Monitoring and Analytics Security Management System and Method is provided for parties, such as channel partners and/or property owners/operators, and provides these parties with a comprehensive monitoring (real-time or historical), analysis and reporting system to help them gain an improved realization of their utility usage, costs, and metrics including the security monitoring of their utility resources, billing errors, operational or equipment problems as well as environmental and societal impacts of their building's activities with the ability to manage and report on these parameters in a way that can alert the user to fraudulent activity or misuse of a building's utilities. The system may include automated data entry from related utility service providers such as energy, water, waste, etc., other data sources such as weather data, applicable property data sources such as occupancy etc, powerful utility analytic metrics and analysis processes, TCP/IP communications capabilities or communication capabilities over cellular networks, a World Wide Web (WWW)-based interface with a Software-as-a-Service (SaaS) architecture, and an Application Programming Interface (API) to communications with other external communication devices and individual Internet-of-Thing (IoT) sensors and systems and other value added services. The system also includes a real-time data retrieval and dissemination process and system which permits real-time utility data and analysis to be communicated immediately within the system. The utility monitoring and analytics security management system has an artificial intelligence (AI) decision engine that has a comparison mechanism and action planner to give the user real-world next step actions and alerts to pre-defined trigger points and recommendations for the optimum security analysis output.

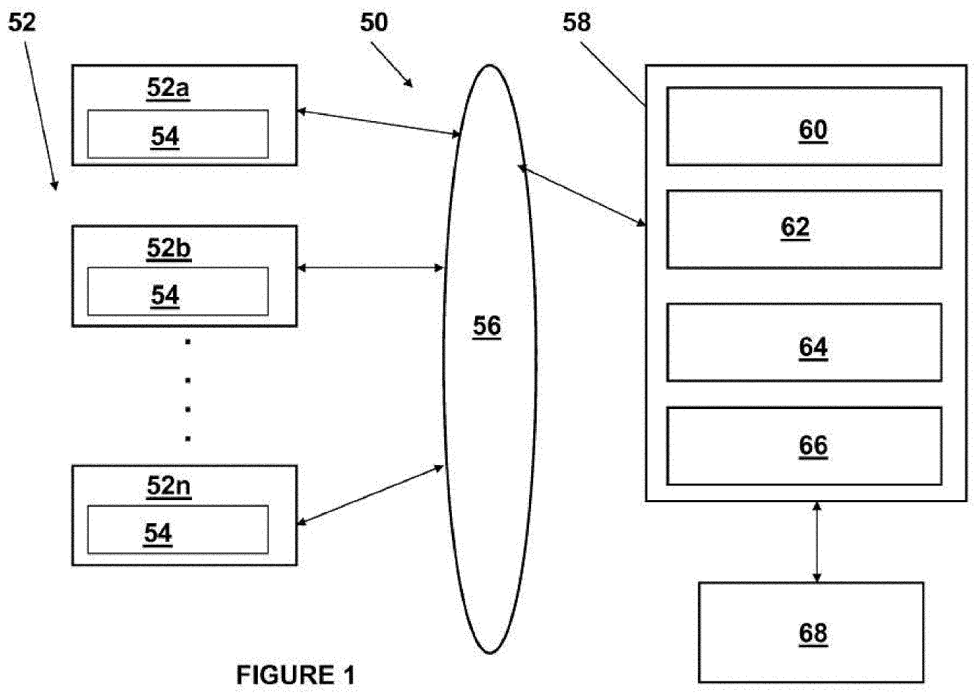

FIG. 1 is a block diagram of an implementation of the utility monitoring and analytics security management system 50. The system 50 may have one or more computing devices 52, such as computing devices 52a, 52b, . . . 52n as shown in FIG. 1) that establish contact with, communicate with and exchange data with a utility monitoring and analytics security management unit 58 over a link 56. Each computing device 52 may be a device with one or more processing unit(s), memory, storage, wireless or wired connectivity capabilities and a display sufficient to permit the computing device 52 to interact with the utility monitoring and analytics security management unit 58 as described below. For example, each computing device 52 may be a desktop computer, a laptop computer, a tablet computer, a smartphone (Apple iPhone, RIM Blackberry, phones that run the Android operating system), a terminal and the like since the implementation of the system is not limited to any particular computing device. In one implementation, each computing device 52 may have a browser 54 that allows the user of the computing device to interact with the utility monitoring and analytics security management unit 58 as described below. In other implementations, the processing unit on each computing device 52 may execute a web browser application or a small downloadable application that can be stored on the computing device and then executed by the processing unit. The link 56 may be a digital data link, that may be wired or wireless, and may be digital cellular network or a computer network since the implementation of the system is not limited to any particular link.

The utility monitoring and analytics security management unit 58 may be, in one embodiment, one or more server computers that execute a plurality of line of computer code to implement the functions and operations of the utility monitoring and analytics security management unit 58 as described below. The utility monitoring and analytics security management unit 58 may also be implemented in hardware or a combination of hardware and software. In one implementation, the utility monitoring and analytics security management unit 58 may utilize, for example, a LAMP stack software bundle or other implementation that allows multiple computing devices in the client environment to be connected to a PHP/MySQL managed database and website user interface (commonly referred to as a Software as a Service, or SaaS). The utility monitoring and analytics security management unit 58 also may be implemented in a standalone computer system architecture, a mainframe type architecture, a downloadable application architecture and the like since the system is not limited to any particular architecture implementation.

In the implementation shown in FIG. 1, the utility monitoring and analytics security management unit 58 may further comprise a web server 60 (that may be software or hardware) that coordinates interactions with the computing devices, receives data from the computing devices and generates outputs, such as web pages, that are delivered to each computing device as needed, a management unit 64 that manages the overall operation of the utility monitoring and analytics security management unit 58, controls the web server 60, manages the user data and manages a security monitoring business development analysis unit 66. The utility monitoring and analytics security management unit 58 may be coupled to a store 68, such as one or more databases for example, that stores the user data of the system, stored security upgrade projects, the analyzed data and the like. The units 60-66 and store 68 may be implemented in hardware or software.

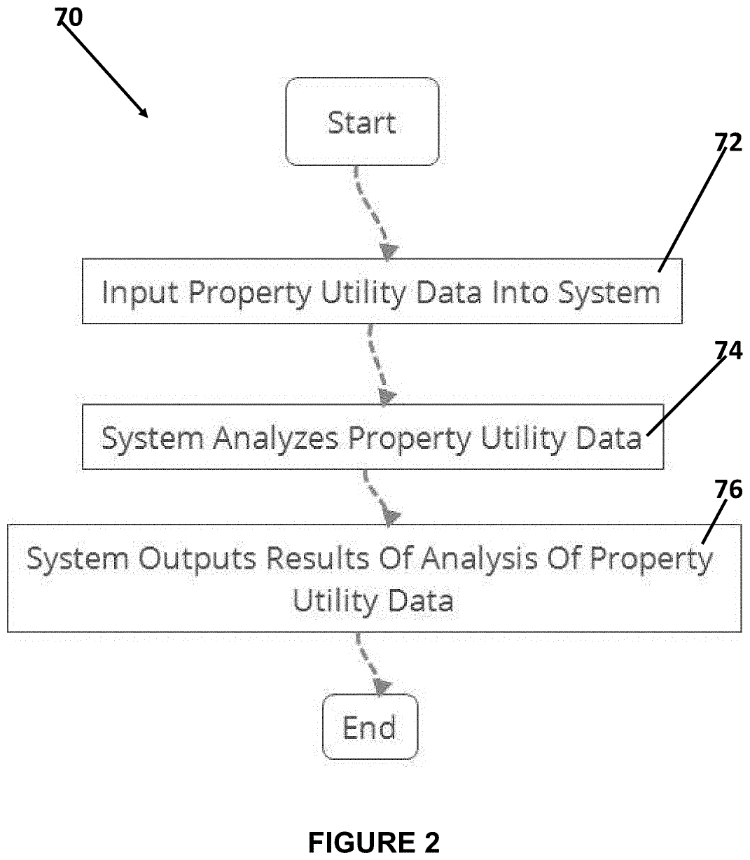

FIG. 2 is a flowchart of a method 70 for utility monitoring and analytics security management using, for example, the system in FIG. 1 for each user of the system when the user wants to receive an output from the system. In general, the system captures user profile data about their property data (including, but not limited to business property size and use, strategic security goals, utility consumption data, etc) and implements a computational process to analyze their historical utility data to current data via interne enabled energy, water or other utility type meters/IoT sensors to alert the user of any potential abnormal or security related activities associated with the building's utilities.

In the method, a user enters property details into the system (72). During the data input process 72, the system may query a user about the one or more desired outputs of the system (such as a particular chart to show a particular security aspect such as energy usage) and the system may then request data from the user about the desired outputs wherein the requested data may include qualitative data and quantitative data. In addition to the user physically entering data into the system, the system also is capable of other input methods including file imports, an API to receive data from other systems, sub-meters, IoT sensors, billing systems and the like. The meters used will primarily be ‘off the shelf’ internet enabled energy, water or other utility type meters that have a user configurable API that the utility monitoring and analytics security management system will use to make a connection with and poll via an internet request at varying increments of time to write/read data to/from the meter as necessary to get the quantity and quality of data we need to produce effective analysis and alerts on usage and cost security issues. These meters could be single ‘whole building’ utility meters, individual utility meters serving specific areas of a location or user installed ‘sub-meters’ on an individual circuit or a combination there of. To retrieve more granular data, the utility monitoring and analytics security management system can use IoT sensors on individual pieces of equipment that uses a utility stream for operation. This might include, pumps, motors, lighting, how water boilers, HVAC systems, plumbing systems etc. The sensors would be internet enabled ‘off the shelf’ type sensors with an API that that we will use to make a connection with and poll via an internet request at varying increments of time to write/read data to/from the sensor as necessary to get the quantity and quality of data we need to produce effective analysis and alerts on usage and cost security issues.

Once the data has been input, the system may perform data analysis (74). During the data analysis, the system may, for example, serve insights into their utility data, such as alerts or data trends, to the user via his/her computing device and also provide potential causes of the insights. The system may also perform a data output process (76) in which the system generates the desired outputs for the particular user. The data output may include system reports on the appropriate metrics (based on the user's desired outputs). The system may have an API that allows the system (and the data outputs of the system) to be broadly adopted/used by other systems that can interface with the utility monitoring and analytics security management system 50.

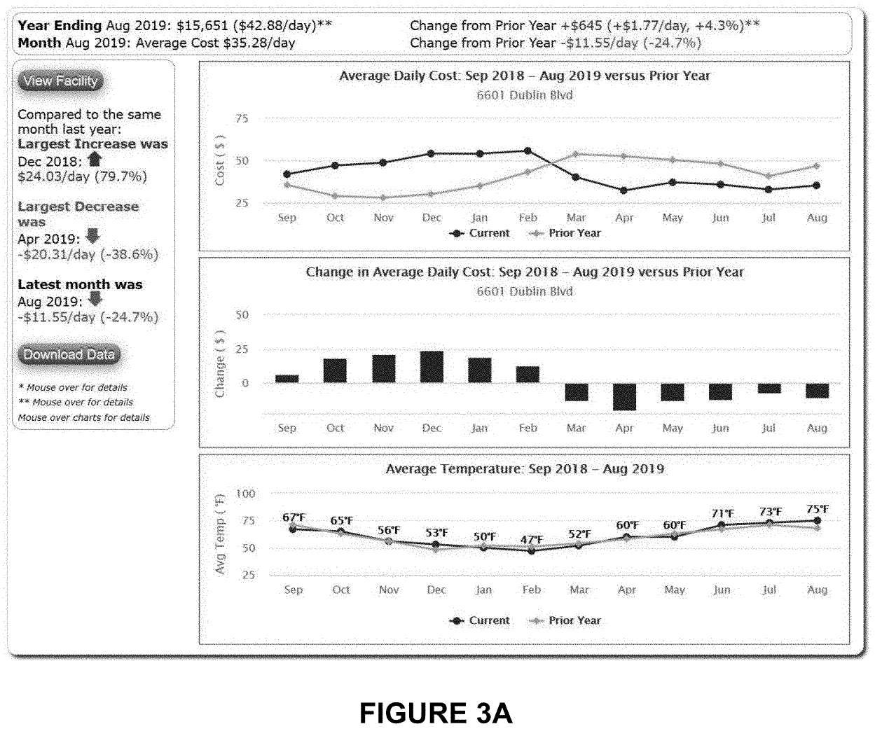

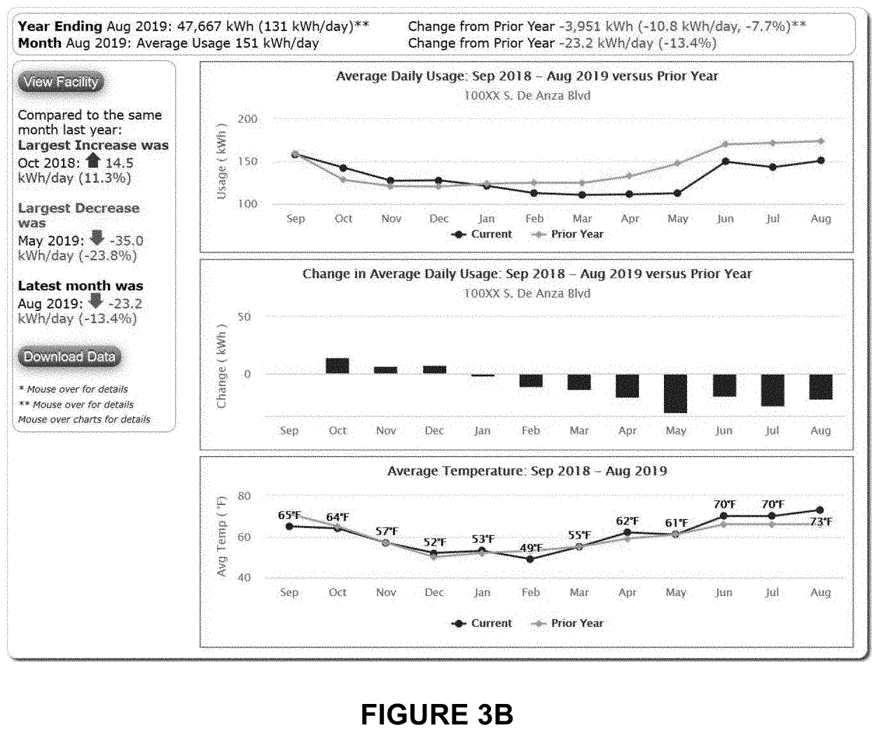

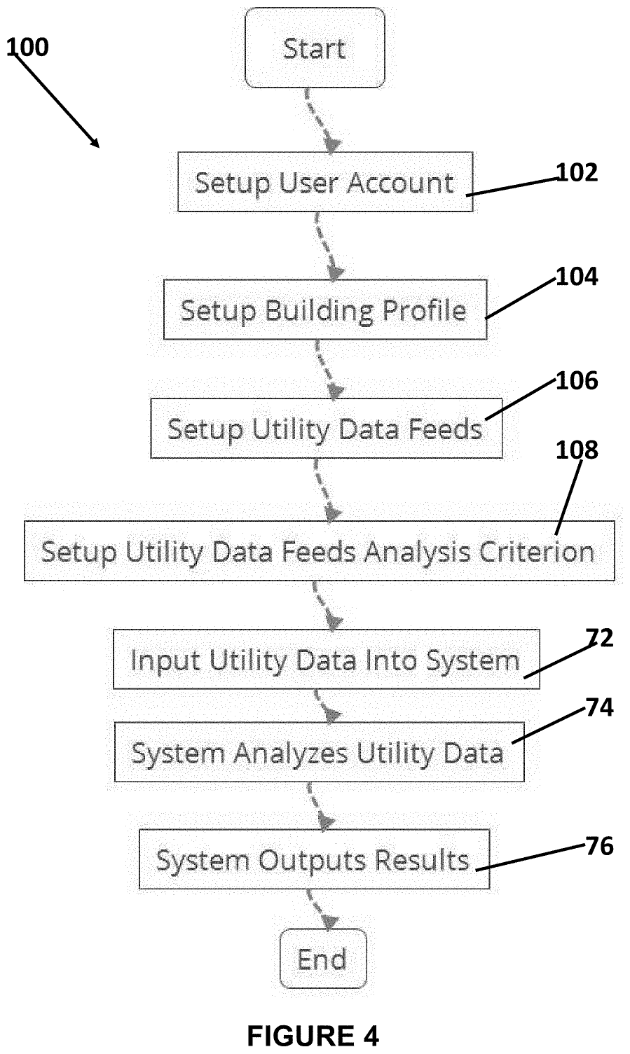

FIG. 3A-B illustrate examples of the output data of the utility monitoring and analytics security management system. FIG. 3A illustrates a data output (shown as a web page in this example) in which the system is displaying electrical cost analysis output over a twenty four month period for a specific customer's building along with associated metrics. The system also may show a variety of other outputs including the main dashboard, suspicious activity report, overall building performance report, a carbon footprint, etc. FIG. 3B illustrates a data output (shown as a web page in this example) in which the system is displaying electrical usage analysis output over a twenty four month period for a specific customer's building along with associated metrics. The system also may display waste, water, etc as well as some qualitative input (e.g., type of business, goal, etc.). FIG. 4 is a flowchart illustrating more details of a method 100 for utility monitoring and analytics security management using, for example, the system in FIG. 1 that incorporates the processes 72-76 described above with more details. The processes described below may be carried out by the system shown in FIG. 1, using web pages, forms and the like. The user provides account login details (102) in which the user, who wants to become a user/member of the utility monitoring and analytics security management system, provides/inputs basic profile information, including, for example, user details, property name, geographic location of property, industry, #employees, etc. Once the user has provided the basic profile information, the user can login to the system (104) over a link using the computing device in which the computing device interacts with the web server of the unit. In an example implementation of the system, the system may be known as Verdafero—Utility Monitoring & Analytics Platform, which is a trademark of the owner of this patent application. The login may be done in a typical manner, securely, using appropriate SSL and/or other security standards.

As part of the process 100, the user may enter building profile information for the building for utility and security monitoring (104) and the utility data feed (106) for the utilities to be monitoring for the building. The data may include building size, year built, construction type, use, utilities used and utility provider. The user may also set up the utility data feed analysis criterion (108), examples of which may be, but not limited to, billing error analysis, utility usage change analysis, utility cost change analysis, trend analysis, building comparison analysis and then the process could proceed through processes 72-76 as shown.

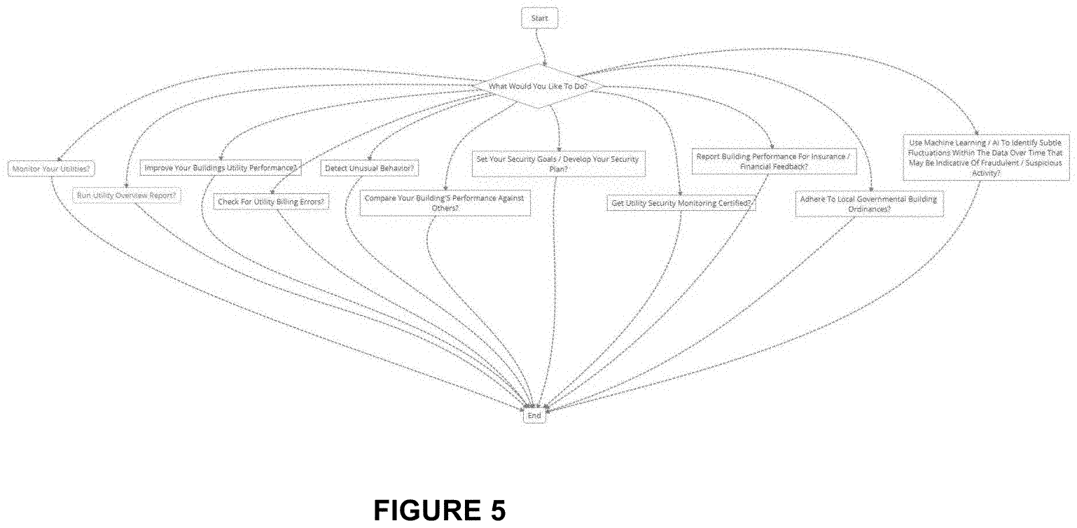

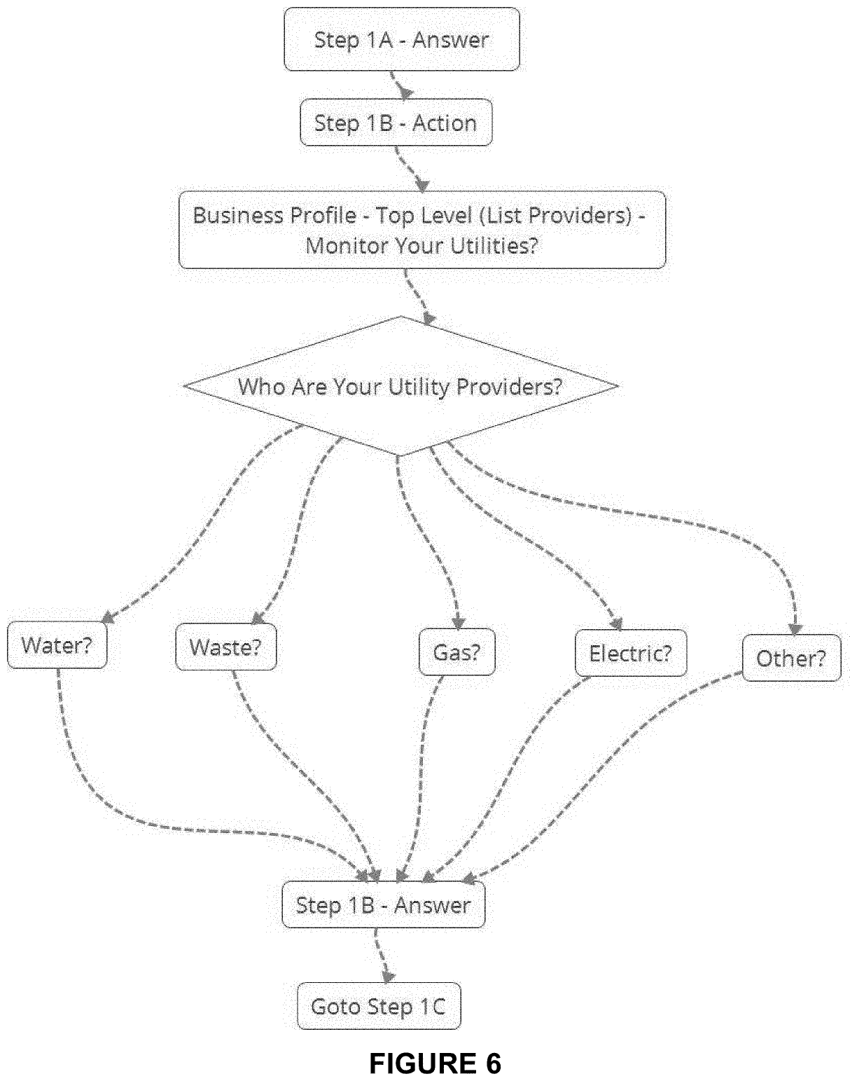

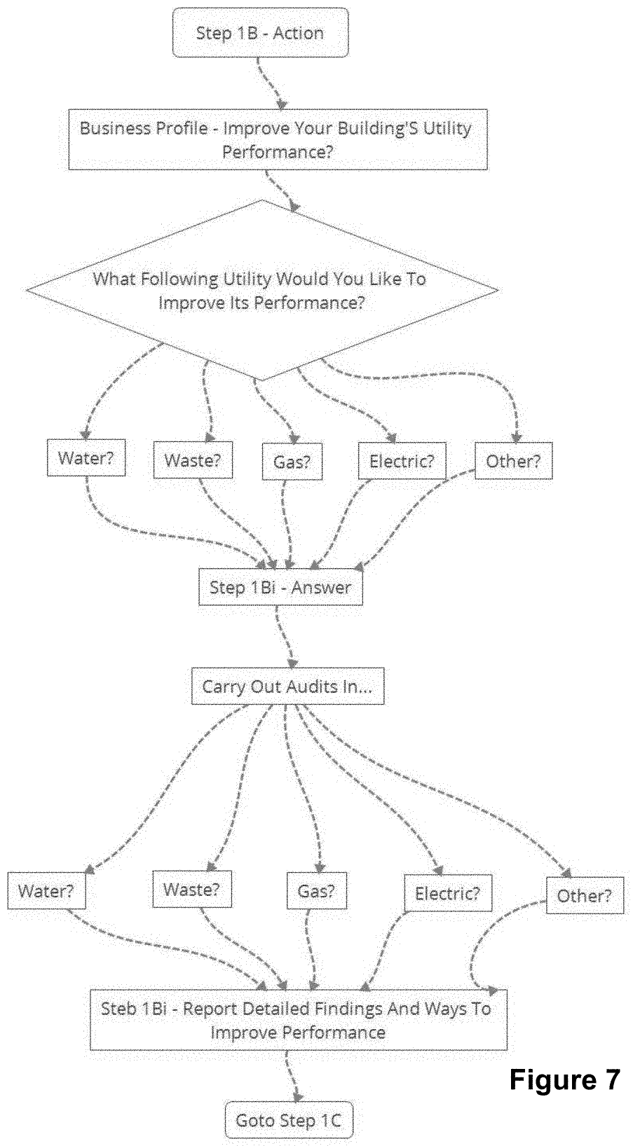

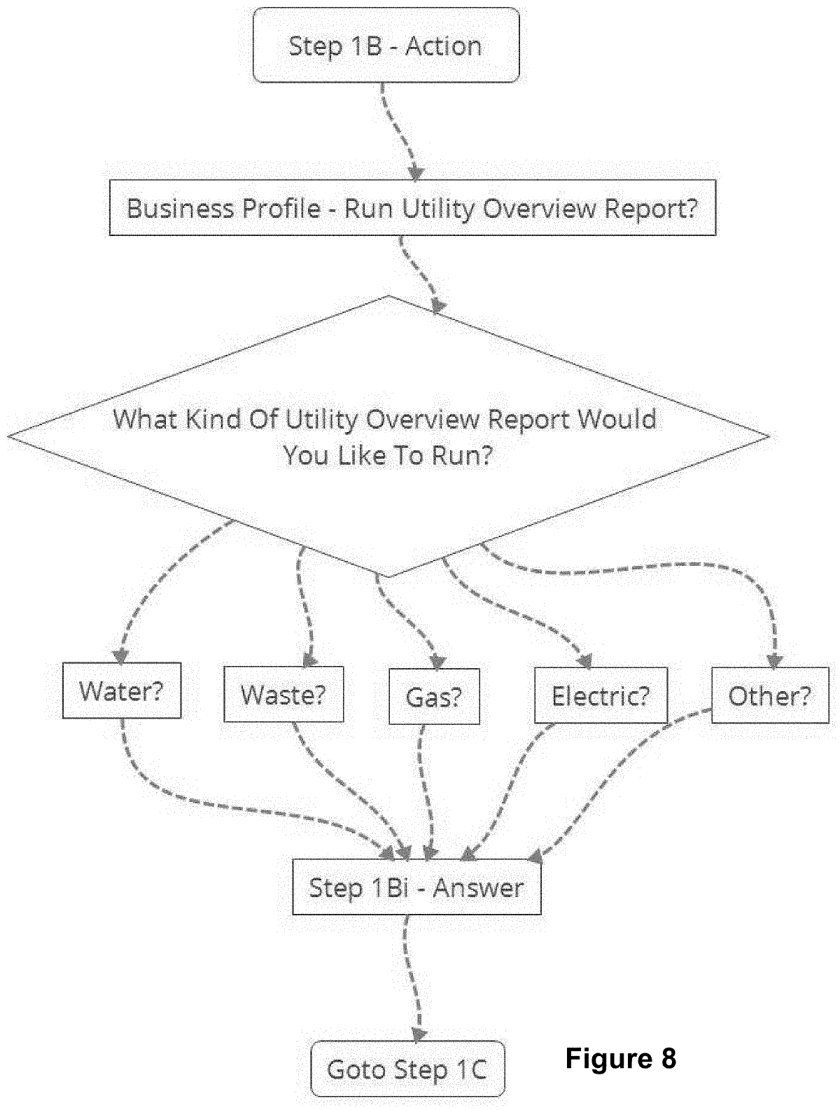

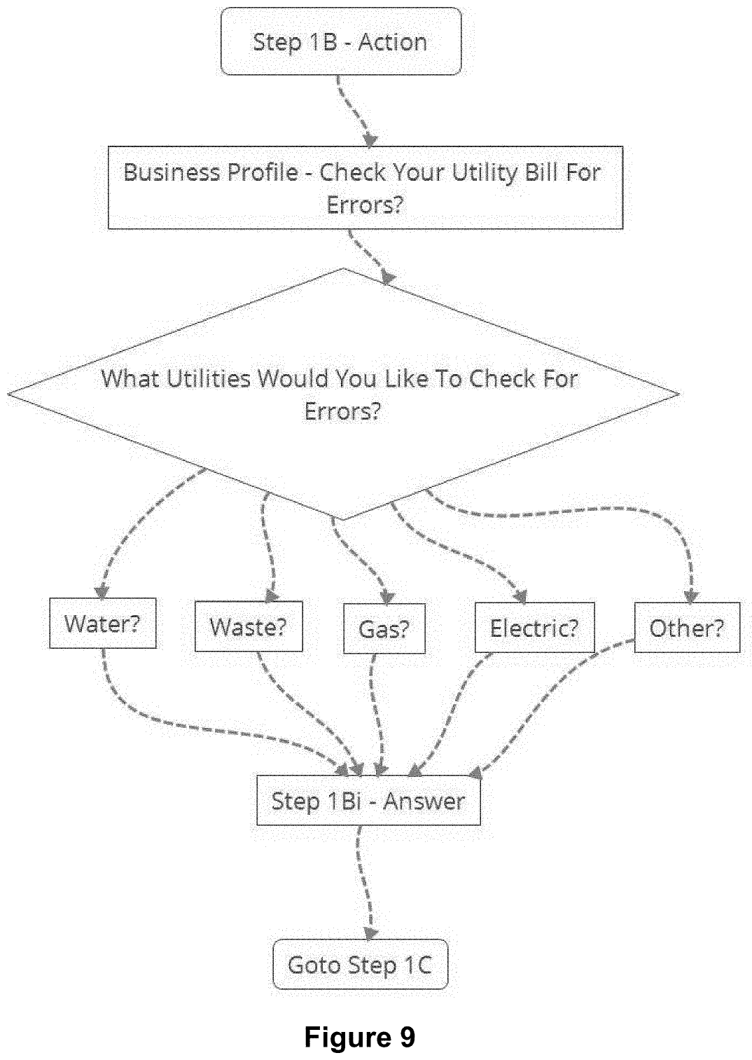

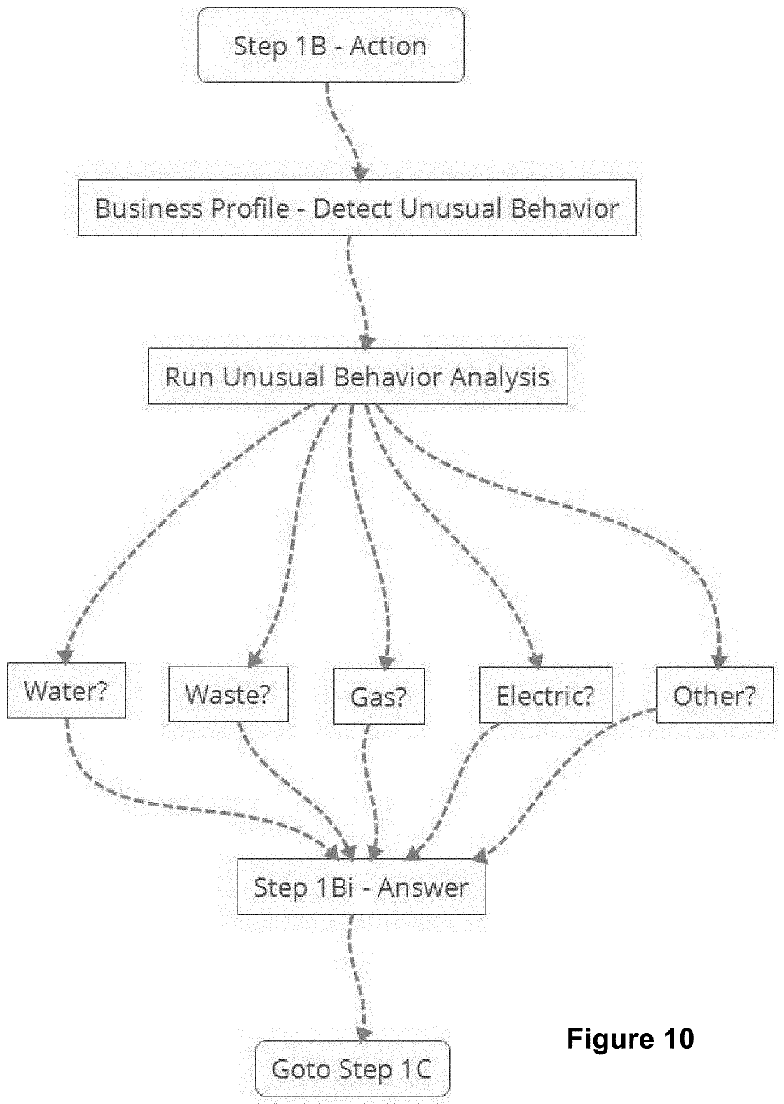

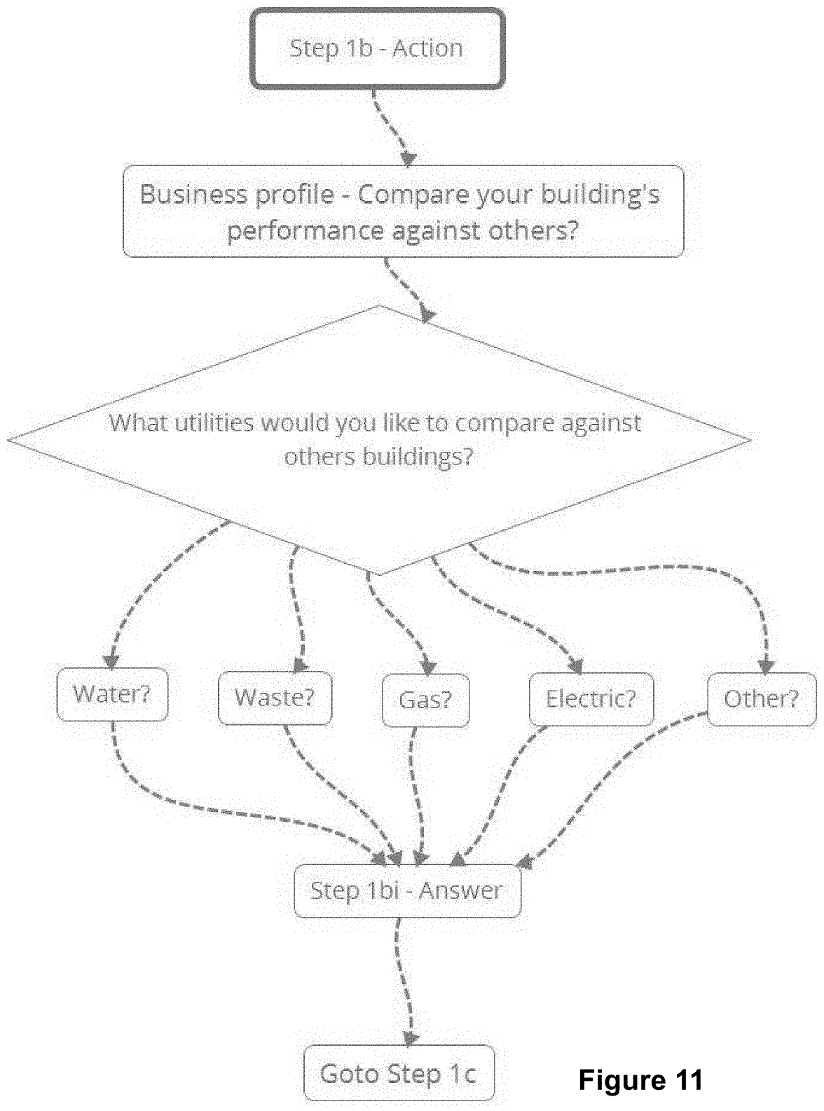

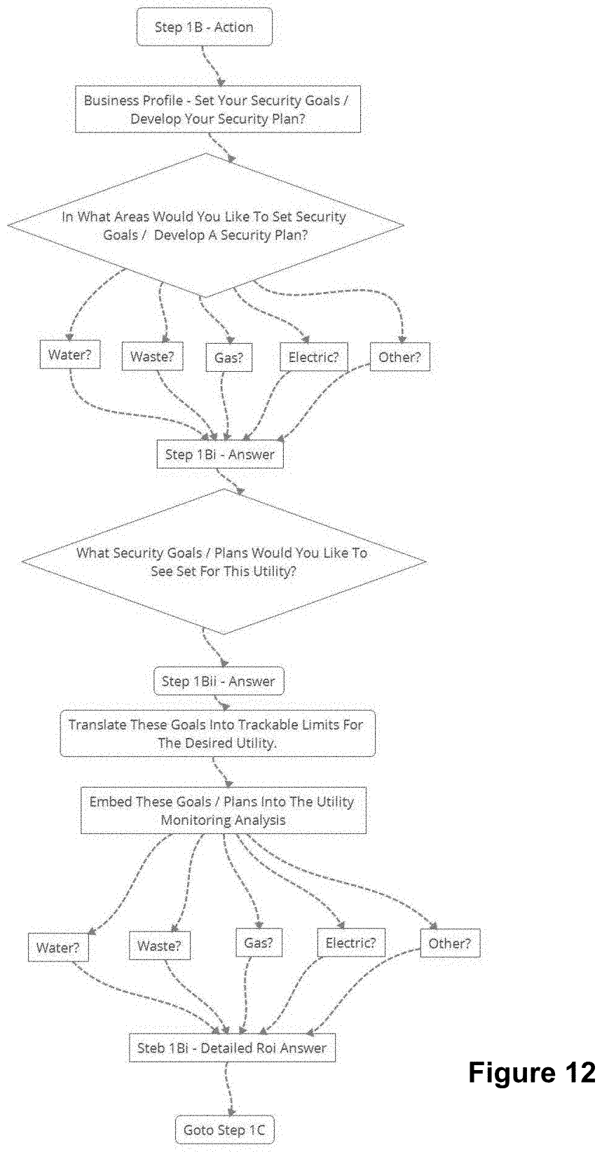

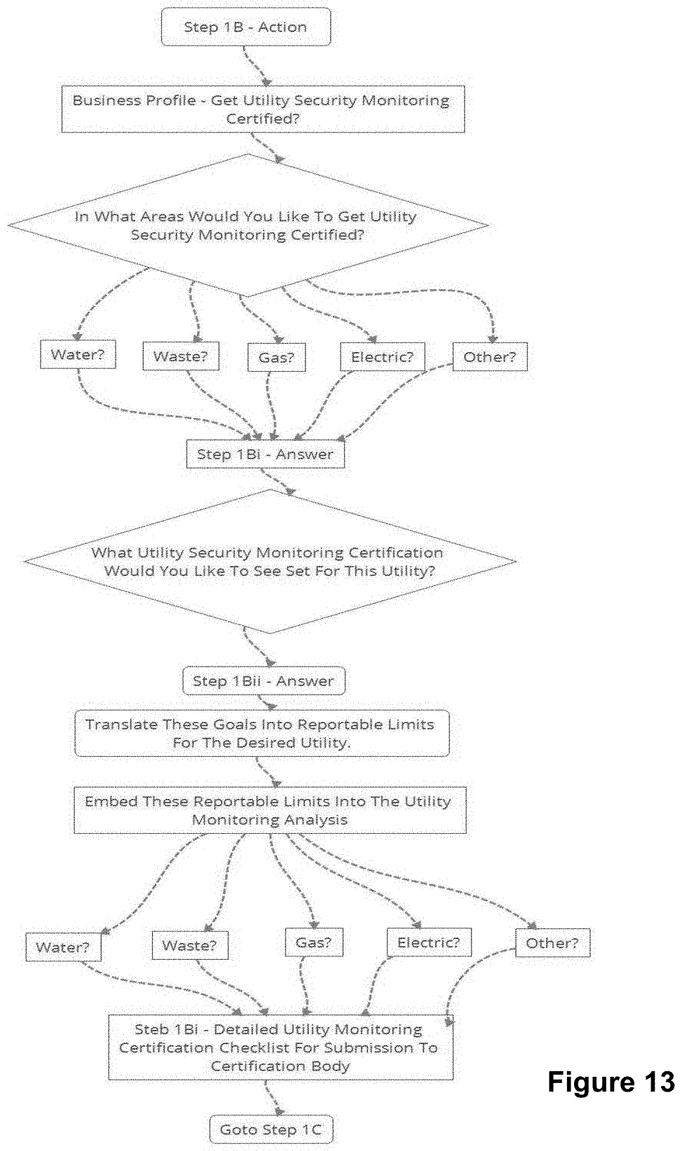

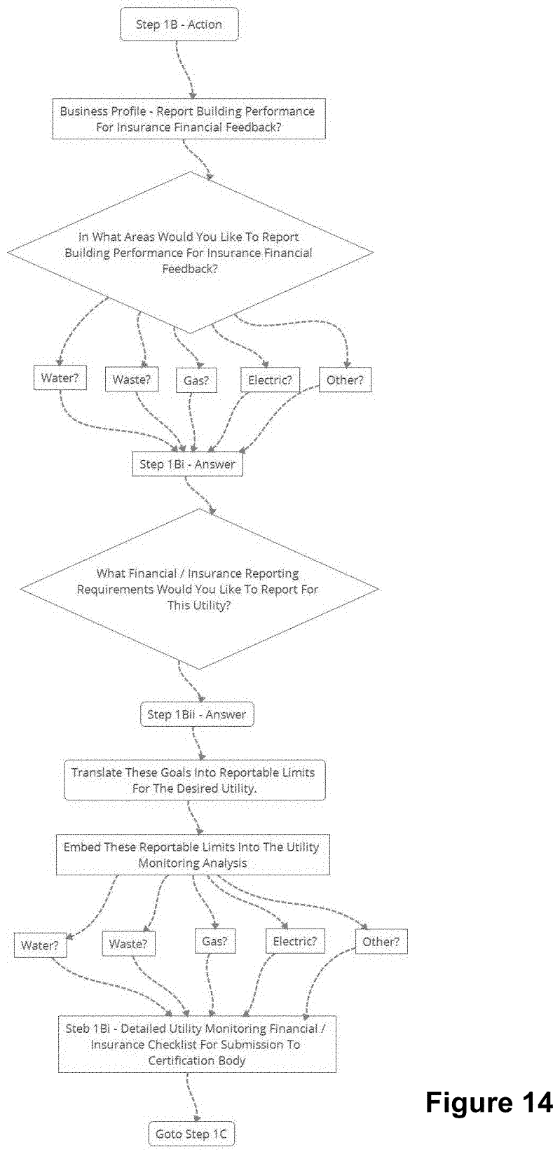

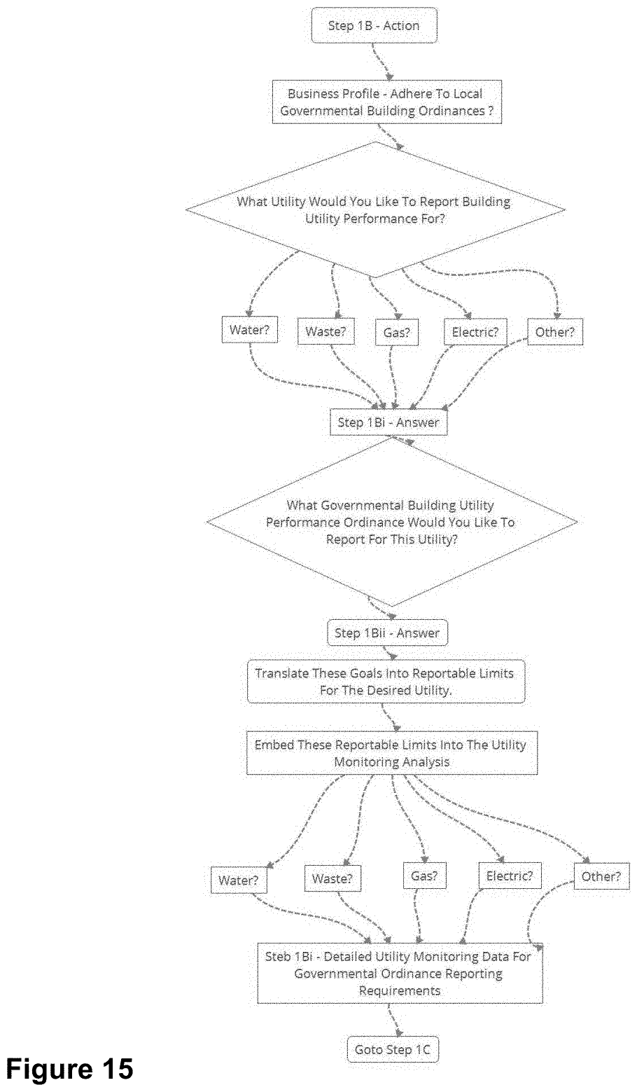

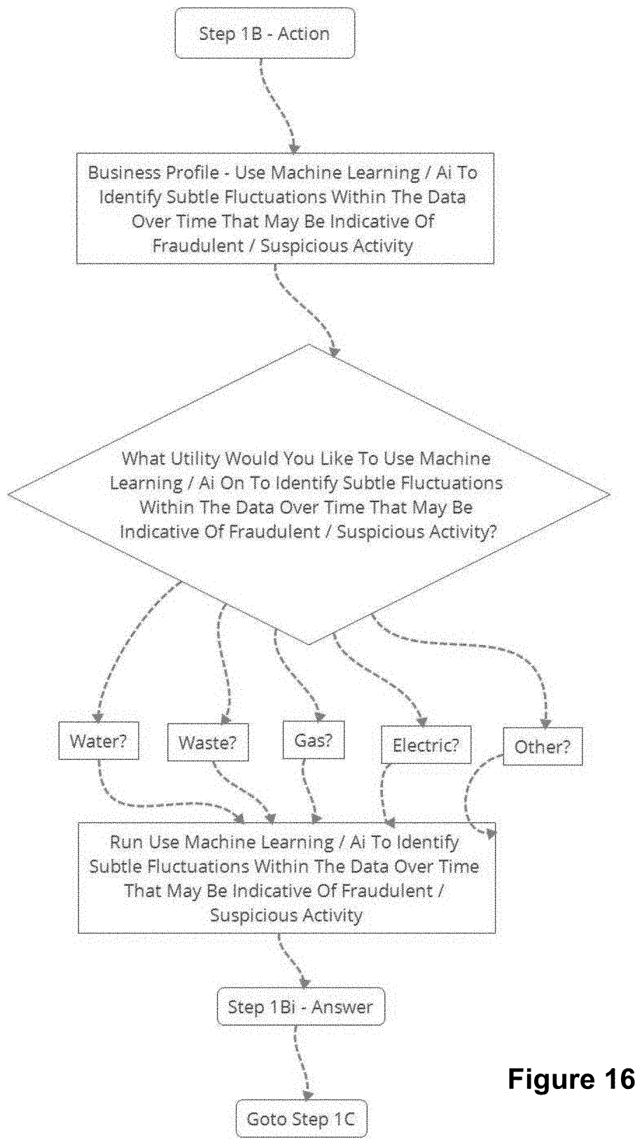

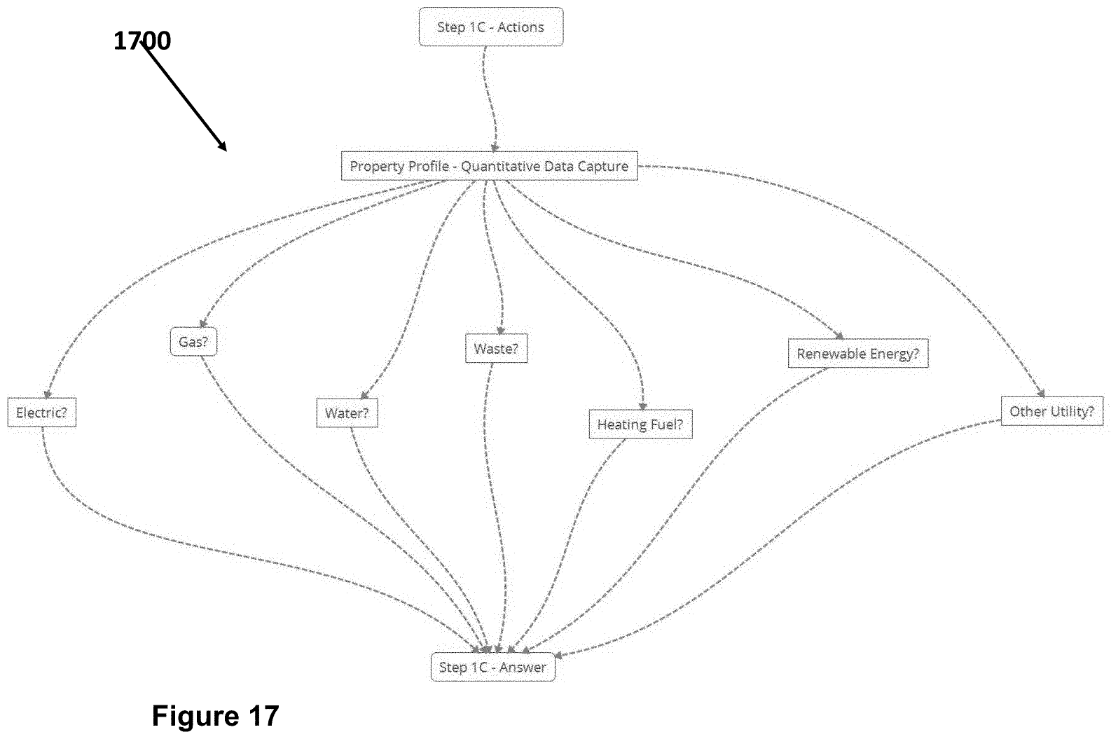

Once the user in logged into the system, the user is asked to respond to a question (which is part of the data input process) and that process is shown in more detail in FIG. 5. As shown in FIG. 5, the user is asked “What would you like to do?” by the system. In one implementation, the user has the options to:
1) monitor building utility usage/costs (the details of the data input for this item as shown in FIG. 6);
2) improve building utility performance (the details of the data input for this item as shown in FIG. 7);
3) produce a utility overview report (the details of the data input for this item as shown in FIG. 8);
4) check your utility bill for errors (the details of the data input for this item as shown in FIG. 9);
5) detect unusual behavior within your utility usage (the details of the data input for this item as shown in FIG. 10);
6) compare your building's performance against others (the details of the data input for this item as shown in FIG. 11);
7) set utility security goals/develop a utility security plan (the details of the data input for this item as shown in FIG. 12);
8) get utility security monitoring certified (the details of the data input for this item as shown in FIG. 13);
9) report building performance for insurance/financial assessment (the details of the data input for this item as shown in FIG. 14);
10) adhere to local governmental building ordinances (the details of the data input for this item as shown in FIG. 15);
11) use machine learning/AI to identify subtle fluctuations within the data over time that may be indicative of fraudulent/suspicious activity (the details of the data input for this item as shown in FIG. 16);
12) The data input may also include quantative data capture that is described in more detail with reference to FIG. 17. The data from all of the data input processes above are stored in the system under the user profile.

If the user selects to monitor their utility usage, the data input process shown in FIG. 6 is performed. To monitor the utility usage, the system asks the user to enter the utility providers (waste, water, watts and others) into the system and then the process proceeds to the process shown in FIG. 17 in which the system does quantitative data capture that includes energy data, water data, transportation data, fuel data and waste data as well as any influencing factors such as weather or occupancy data.

The qualitative data capture process 1700 shown in FIG. 17 may be used by various processes as described below. In the data capture process 1700 various pieces of data about each utility, such as electric, gas, water, heating fuel, renewable energy and/or other utilities may be captured by the process. Examples of the type of data captured for each utility may be, but not limited to, electrical current, voltage, power data, gas flow rate and volume data, water flow rate and volume data and biomass weight, volume, calorific data and trash volume, weight data etc.

If the user wants to improve building utility performance, the data input process shown in FIG. 7 is performed. The system, as shown in FIG. 7, asks which utility (which include the ones shown in FIG. 7 such as waste, water, transportation, etc. that are referred to hereafter as the “utility areas”) the user would like to improve its performance and then suggests to carry out an audit on that utility to establish ways to improve performance. Examples of these audits may include, but not limited to, electrical energy audits, gas audits, waste audits of differing levels providing differing levels of analysis and insight. Once completed, the system goes to the quantitative data capture process shown in FIG. 17.

If the user wants to report their findings in the form of a utility overview report, the data input process shown in FIG. 8 is performed. During the process, the system determines the type of report that the user wants, such as a carbon footprint report, comparison report or a different report, and generates the report output for the user. Once completed, the system goes to the quantitative data capture process shown in FIG. 17. Depending on the user selected report, the system may have a reporting algorithm to analyze the data and format that data such that an overview report can be displayed and printed. Other Verdafero developed algorithms may be used to detect and report usage/cost change alerts over time or changes in the utility rate which can call out several problem factors for further attention.

If the user wants to check the utility bills for errors, the data input process shown in FIG. 9 is performed. During the process, the system determines if there has been a billing error, or some other type of miscalculation within the billing data and generates the analysis output for the user. Once completed, the system goes to the quantitative data capture process shown in FIG. 17. For example, as part of the billing error analysis the system can compare the usage and cost over the same periods this year and last year to determine if there is a dramatic increase in cost per unit of utility. If this change is outside a predetermined value it may indicate, amongst other things, a potential error or miscalculation in the utility bill.

If the user wants to be alerted to abnormalities/potential security problems/unusual behavior within your utility usage the analysis of their utility usage, the data input process shown in FIG. 10 is performed. During the process, the system runs unusual behavior analysis on the chosen utility which may include, for example, using our trending analysis algorithm to compare a user's historically usage pattern against their current usage pattern to identify any abnormalities which could indicate potential security problems or unusual behavior and generates the alert output for the user. Once completed, the system goes to the quantitative data capture process shown in FIG. 17.

If the user wants to compare your building's performance against others, the data input process shown in FIG. 11 is performed. During the process, the system runs the comparison analysis which may include, for example, using our energy usage analysis algorithm, including normalizing to any external influencing factors such as weather or occupancy etc, to calculate the energy use intensity of the user's building to compare the particular building's utility data with comparable buildings in Verdafero's database or accessible to Verdafero through multiple sources and generates a comparison analysis report output for the user. Once the data gathering about the certifications is completed, the system goes to the quantitative data capture process shown in FIG. 17.

If the user wants to set utility security goals/develop utility monitoring security plan, the data input process shown in FIG. 12 is performed. During the process, the system inquires as to whether the user/property has existing security goals or a utility monitoring security plan. If the property does not have an existing security goals or a utility monitoring security plan, the system can guide the user through a process of questions designed to analyze their current situational utility monitoring security plan against predefined standards and guide them to select predefined comprehensive utility security goals and/or develop a comprehensive utility monitoring security plan specific to their individual needs. Once the data gathering about the certifications is completed, the system goes to the quantitative data capture process shown in FIG. 17.

If the user wants to get utility security monitoring certified, the data input process shown in FIG. 13 is performed. During the process, the system asks the user about what certification that would like to receive. The certification standards could be from, but not limited to, a list of industry recognized security certifications or Verdafero defined security certifications depending on the user's preference. Given these inputs and based on Verdafero's utility monitoring algorithm analysis of their utility data the system can produce the necessary reporting documentation required by the certifying body in several required output formats and, if desired, have it sent to the certifying body for review. Once the data gathering about the education is completed, the system goes to the quantitative data capture process shown in FIG. 17.

If the user wants to report building performance for insurance/financial assessment purposes, the data input process shown in FIG. 14 is performed. During the process, the system asks the user about what insurance/financial institution they would like to report their building's performance to or to what standards and analysis these institutions are specifically requiring. Given this input and based on Verdafero's utility monitoring algorithm analysis the system can produce the necessary documentation required by the institution in a desired output format and, if desired, have it sent to the institution for review. Once the data gathering about the education is completed, the system goes to the quantitative data capture process shown in FIG. 17.

If the user wants to adhere to local governmental building ordinances, the data input process shown in FIG. 15 is performed. During the process, the system asks the user about what local governmental building ordinance they would like to report their building's performance to. Given this input and based on Verdafero's utility monitoring algorithm analysis and possible communications with other external software systems like the Environmental Protection Agency's ENERGY STAR, the Verdafero system can produce the necessary documentation required by the ordinance body in a desired output format and, if desired, have it sent to the ordinance body for review or interface with the ordinance body's system of choice and report the building's performance. Once the data gathering about the education is completed, the system goes to the quantitative data capture process shown in FIG. 17.

If the user wants to identify fraudulent/suspicious activity using machine learning/AI, the data input process shown in FIG. 16 is performed. During the process, the system asks the user which utility they would like to analyze for fraudulent/suspicious activity? Given this input the system can run analysis to identify subtle fluctuations within the data over time that may be indicative of fraudulent/suspicious activity and report the findings to the user. The process continually monitors the utility usage over time, short or longer periods, and using the AI engine, and based on identified patterns extracted from Verdafero's utility monitoring AI algorithm analysis, identifies potential fraudulent/suspicious activities that have not been seen in the past, such as usage spikes during unoccupied times of the day, higher load profiles at unexpected times, be it singular or regular occurrences. If these spikes/abnormalities identified as non-suspicious the AI engine can learn to incorporate these non-suspicious events as normal behavior for future events. Once the data gathering about the education is completed, the system goes to the quantitative data capture process shown in FIG. 17.

During the quantitative data capture process shown in FIG. 17, the system captures data about the one or more utility monitoring areas as shown and the quantitative data is stored in the system indexed against the user's profile. The data is automatically captured via computer scanning of paper or PDF utility bills via character recognition software, via direct connection to internet enabled smart utility meters, off the shelf internet enabled sub-meters or internet enabled IoT sensing device on individual pieces of equipment etc. Verdafero will read/write to each wed-enabled device through the devices specified API and store the information in our desired format on our servers in preparation for analysis in our machine learning/AI analysis algorithm.

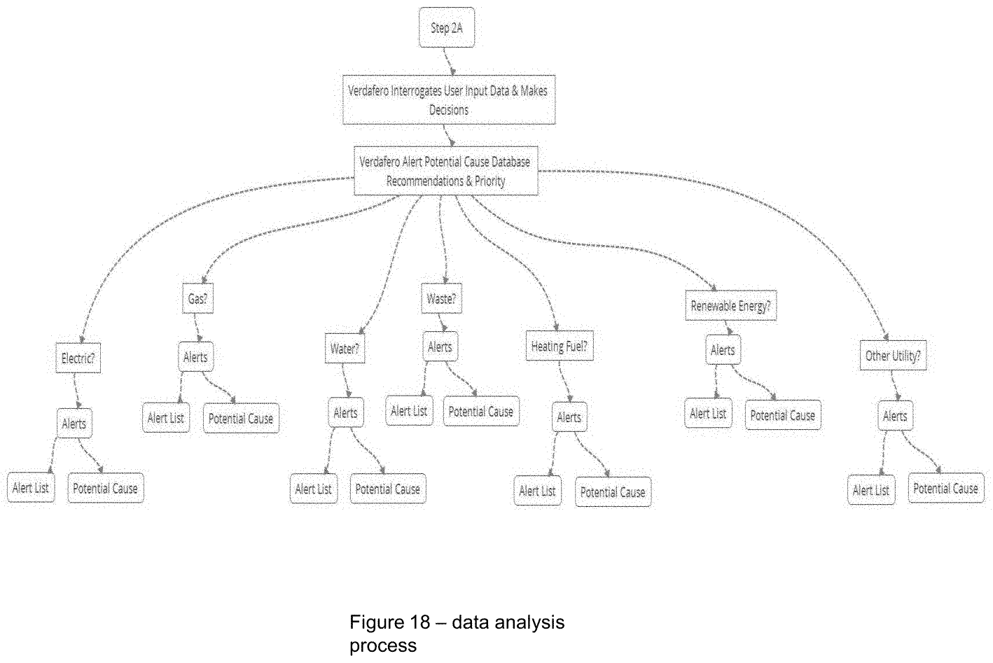

Returning to FIG. 4, once the data input is completed, the process moves onto the data analysis process 74 that is shown in more detail in FIG. 18. During the analysis process, the system implements an analysis algorithm to take into account internal or external factors, that may influence utility usage to determine a list of utility security priorities for the particular user/business based on the input data. Based on the predefined user security priorities set by the building owner/operator or security personnel assisting the building owner/operator such as, “send an alert if usage increase is in access of 25% over a certain time period” or “if the trend analysis indicates an event or set of events that lie outside a set normal pattern alert the user to its existence”, the system can determine if one or more utility monitoring areas may be outside the scope of normal behavior, based on the historical Verdafero analysis algorithm and other Verdafero data analysis algorithms, may prioritize the alerts and recommendations, and/or provide links to products/services related to the recommendations/projects to investigate these abnormalities further. The links to possible products/services related to the recommendations/projects may be based upon an AI decision engine that taking into account the building's location, use and other relevant data and alerting factors, can present the user the most useful product/service solutions to their problem. Examples of this may be a catastrophic water leak detected on the top floor of the building requiring immediate attention from a qualified plumber. Following the system detection of this leak it would immediately identify an appropriate plumber, from a user predefined list or public database, and present the user with necessary details. Thus, as shown in FIG. 18, the system can make security recommendations in one, a few, many or all of the one or more utility monitoring areas. For each utility monitoring area, the system may provide a project list of one or more projects in that utility monitoring area to investigate as the cause of the alert and/or a list of service providers to help with investigating the cause of the alert.

The system may permit the projects to be sorted by: profile such as the type of building (such as industry vertical or similar); ownership status of facilities, 3rd party hosting, etc.; security projects & security certifications already completed; security goals for organization, such as alert if electricity changes by x% and/or if water changes by x%; and/or other utility analysis abnormality.

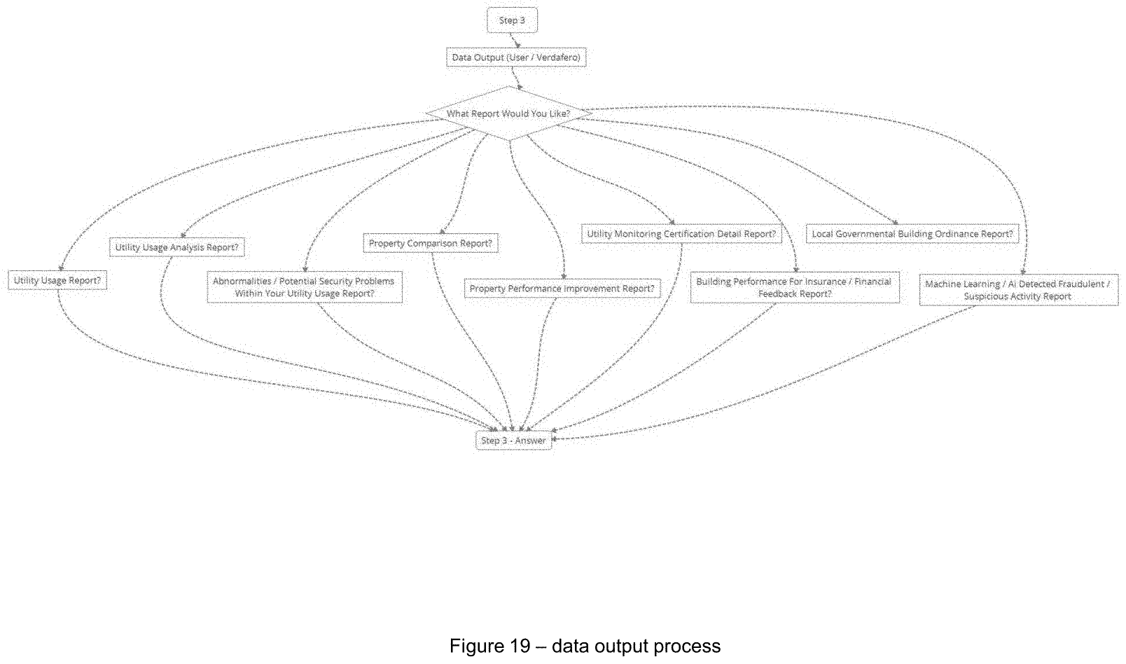

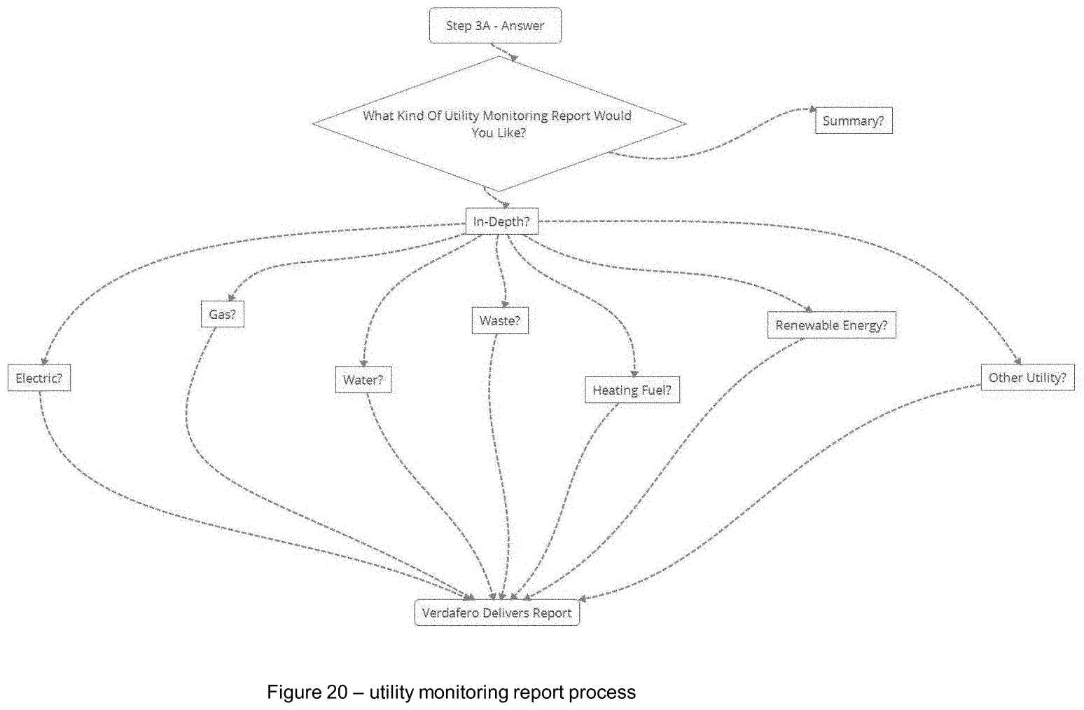

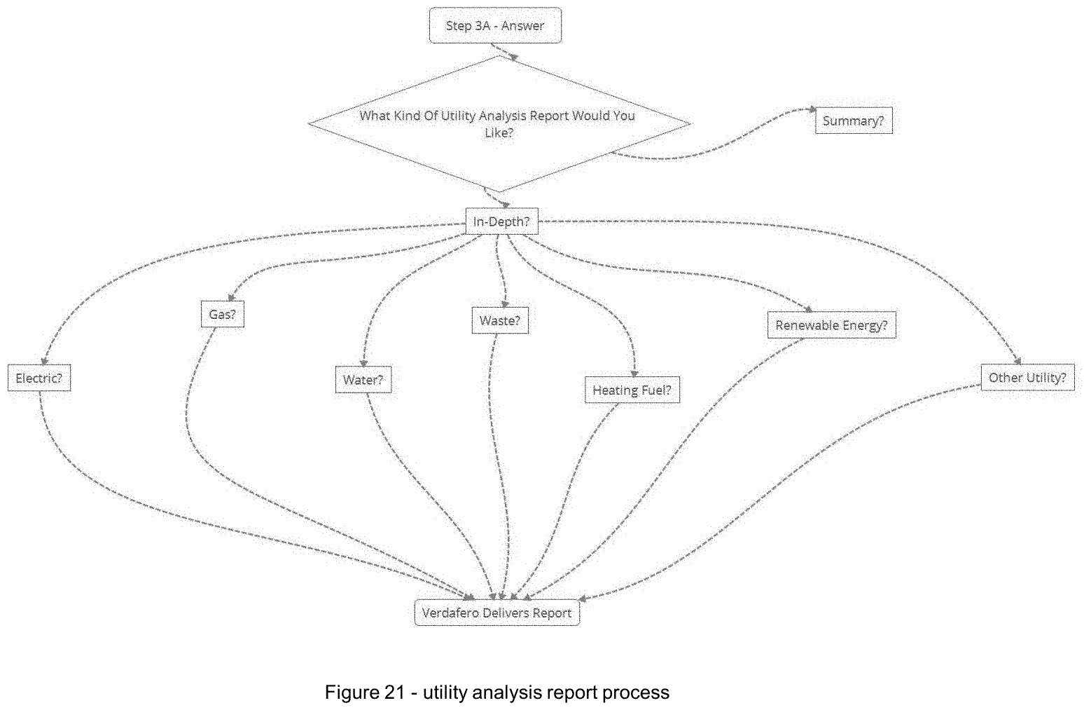

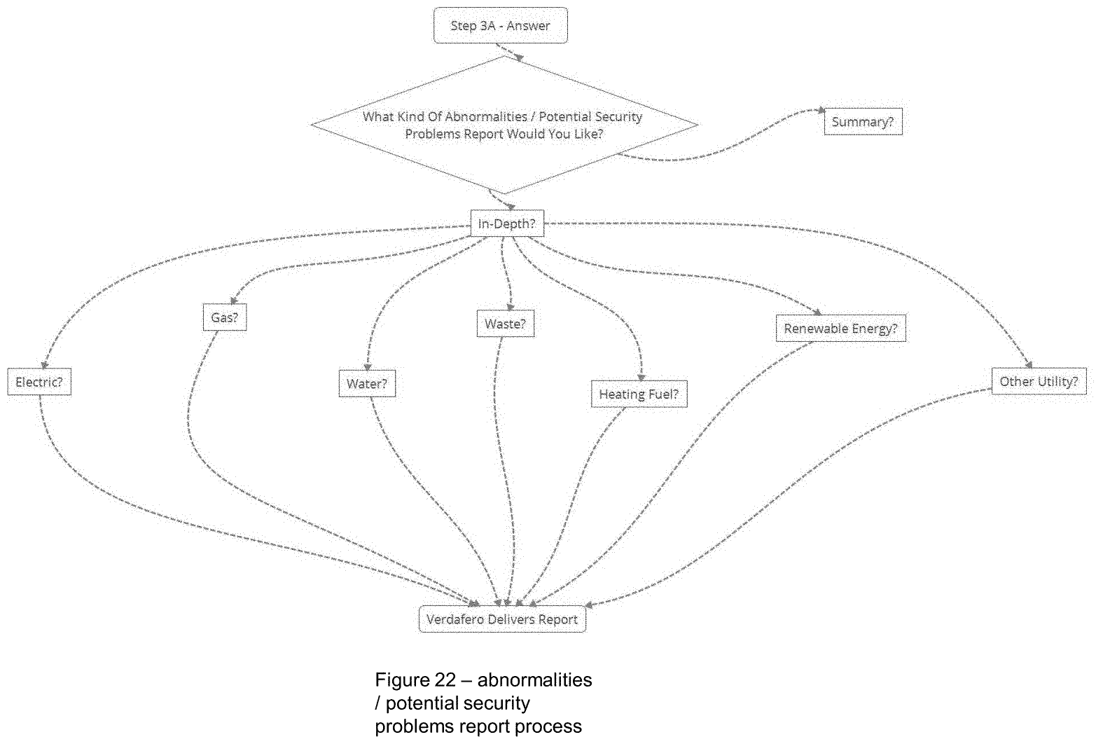

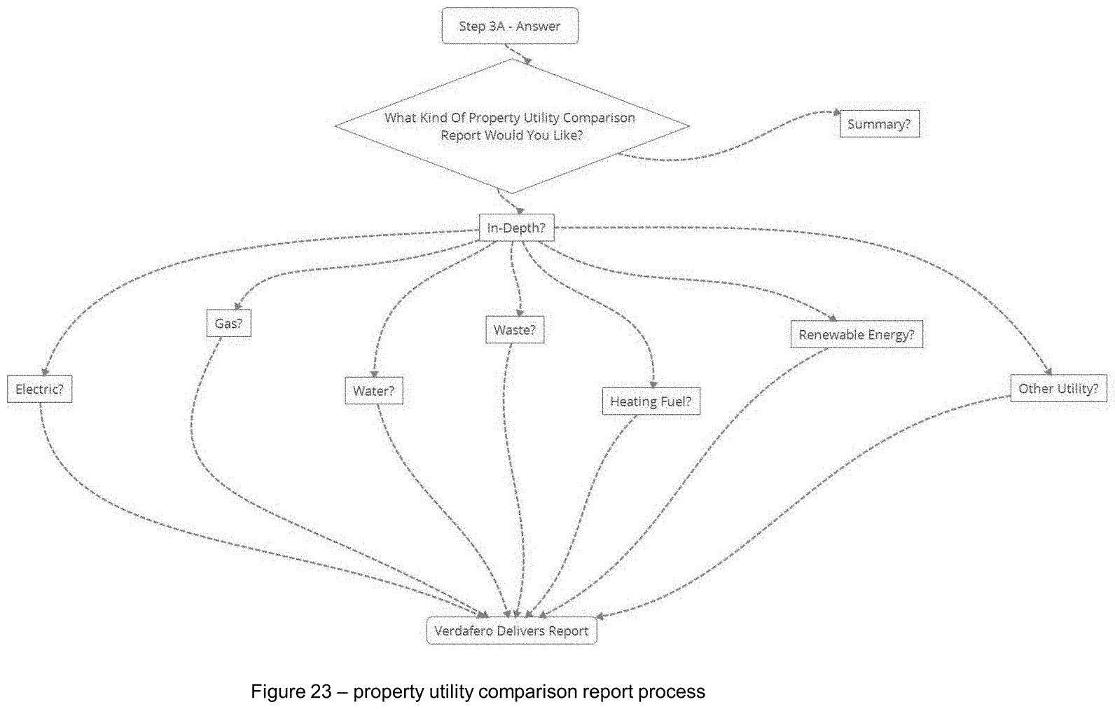

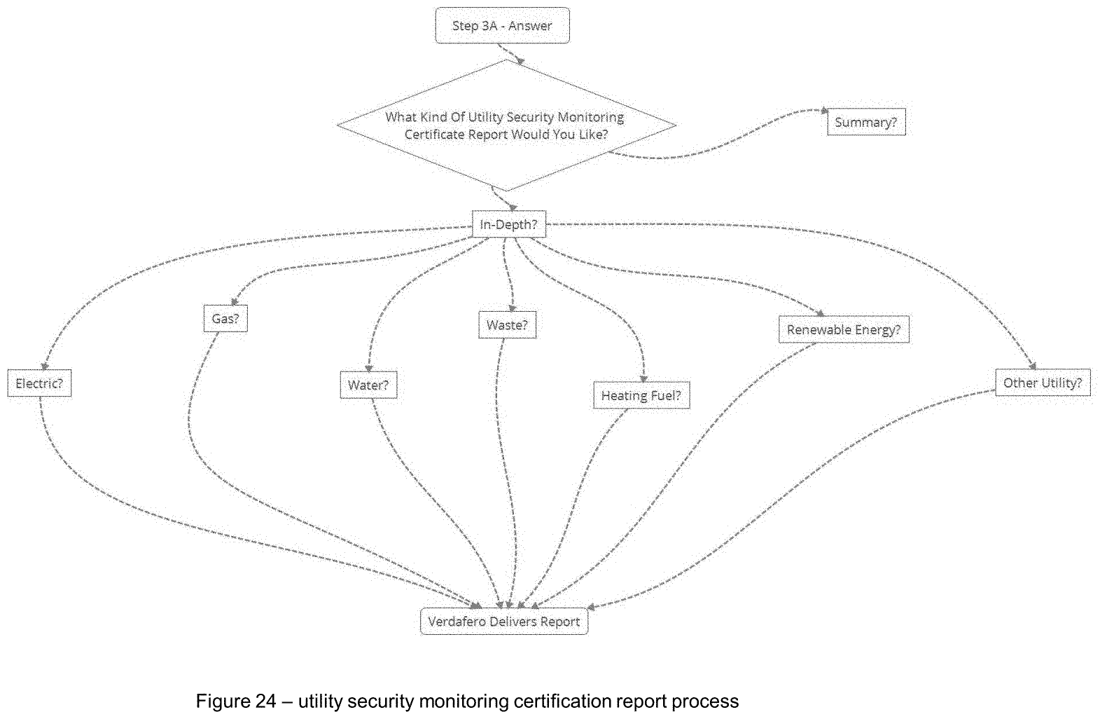

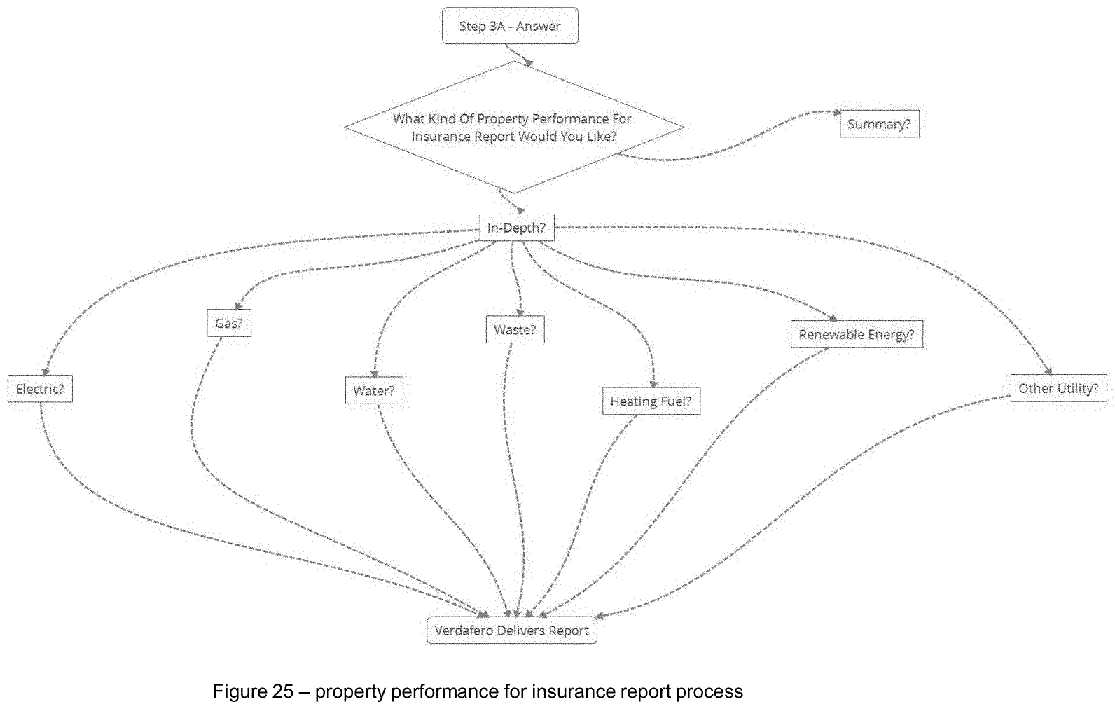

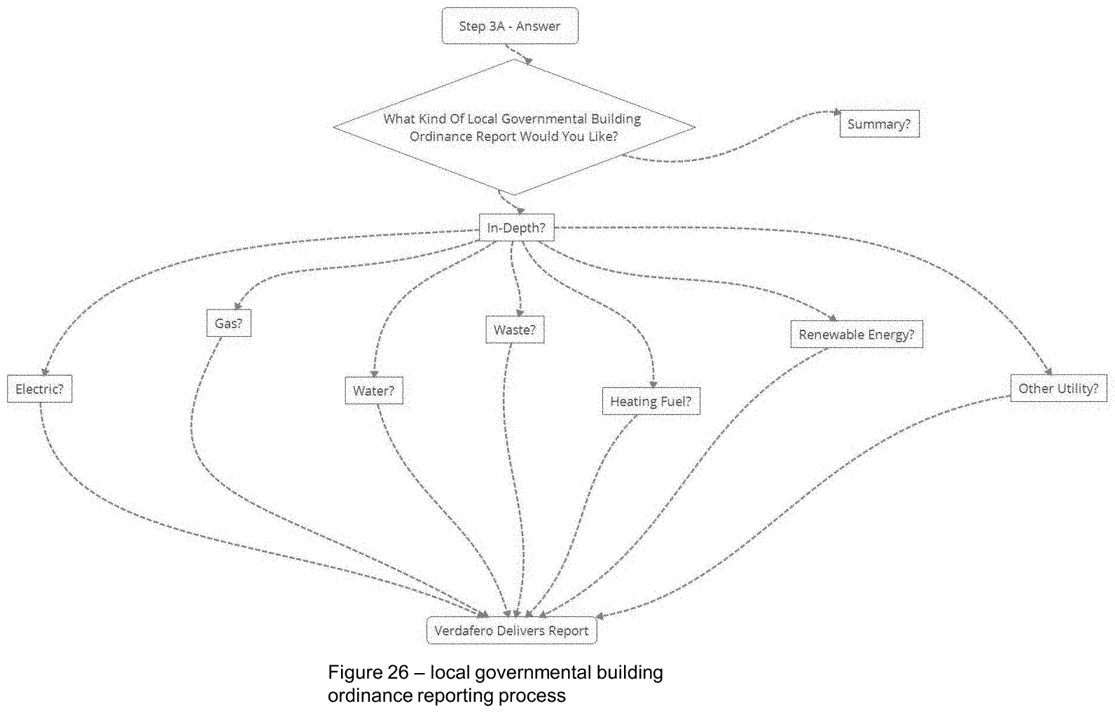

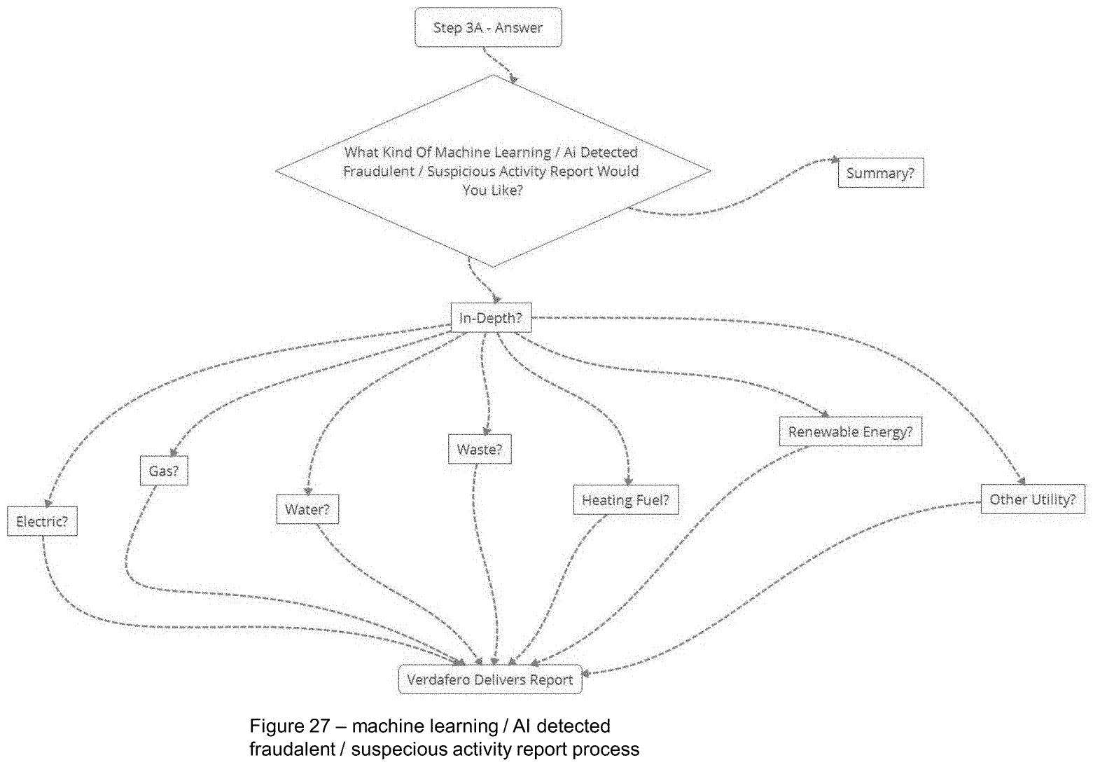

As shown in FIG. 4, once the data analysis is completed for the particular user/property, the process moves onto the data output process 76. During the data output process, the system allows the particular user to select the one or more desired outputs and the reports output A/R. In the data output process, the user may be presented with views (dashboard) and/or print, .pdf, etc. of: * Utility Monitoring Report; Security performance details (metrics); Overall Security Health Report; and/or Status details A/R. Thus, during the data output process, the user may select a report (as shown in FIG. 19) that may include:
a utility monitoring report (the details of which process to generate the report are shown in FIG. 20);
a utility analysis report (the details of which process to generate the report are shown in FIG. 21);
an abnormalities/potential security problems report (the details of which process to generate the report are shown in FIG. 22);
a property utility comparison report (the details of which process to generate the report are shown in FIG. 23);
a utility security monitoring certificate report (the details of which process to generate the report are shown in FIG. 24);
a property performance for insurance assessment report (the details of which process to generate the report are shown in FIG. 25);
a local governmental building ordinance report (the details of which process to generate the report are shown in FIG. 26);
a machine learning/AI detected fraudulent/suspicious activity report (the details of which process to generate the report are shown in FIG. 27); and other reports that the system can generate or that can be created by the user.

During the utility monitoring report process as shown in FIG. 20, the system determines if the user wants a utility security summary and can provide that to the user (an example of which is contained in Appendix A which is incorporated herein by reference) or an in-depth report related to the one or more utility monitoring areas and can then provide those reports.

During the utility analysis report process as shown in FIG. 21, the system determines if the user wants a utility analysis report summary and can provide that to the user or an in-depth report related to the one or more utility monitoring areas and can then provide those reports.

During the abnormalities/potential security problems report process shown in FIG. 22, the system determines if the user wants a abnormalities/potential security problems report summary and can provide that to the user or an in-depth report related to the one or more utility monitoring areas and can then provide those reports.

During the property utility comparison report process shown in FIG. 23, the system determines if the user wants a property utility comparison report summary and can provide that to the user or an in-depth report related to the one or more utility monitoring areas and can then provide those reports.

During the utility security monitoring certificate report process shown in FIG. 24, the system determines if the user wants a utility security monitoring certificate report summary and can provide that to the user or an in-depth report related to the one or more utility monitoring areas and can then provide those reports.

During the property performance for insurance report process shown in FIG. 25, the system determines if the user wants a property performance for insurance report summary and can provide that to the user or an in-depth report related to the one or more utility monitoring areas and can then provide those reports.

During the property performance for a local governmental building ordinance report process shown in FIG. 26, the system determines if the user wants a local governmental building ordinance report summary and can provide that to the user or an in-depth report related to the one or more utility monitoring areas and can then provide those reports.

During the machine learning/AI detected fraudulent/suspicious activity report process shown in FIG. 27, the system determines if the user wants a machine learning/AI detected fraudulent/suspicious activity report summary and can provide that to the user or an in-depth report related to the one or more utility monitoring areas and can then provide those reports. The machine learning/AI detected fraudulent/suspicious activity report summary consists of a high-level overview through graphical interfaces and associated descriptive detail of if your property portfolio or individual facility may have been subject to fraud/suspicious behavior within its utility use. The machine learning/AI detected fraudulent/suspicious activity report detailed report consists of an in-depth view through graphical interfaces and associated descriptive detail if your property portfolio, individual facility has been subject to fraud/suspicious behavior within its utility use down to the, meters or sensors level so you can pin point the affected party.

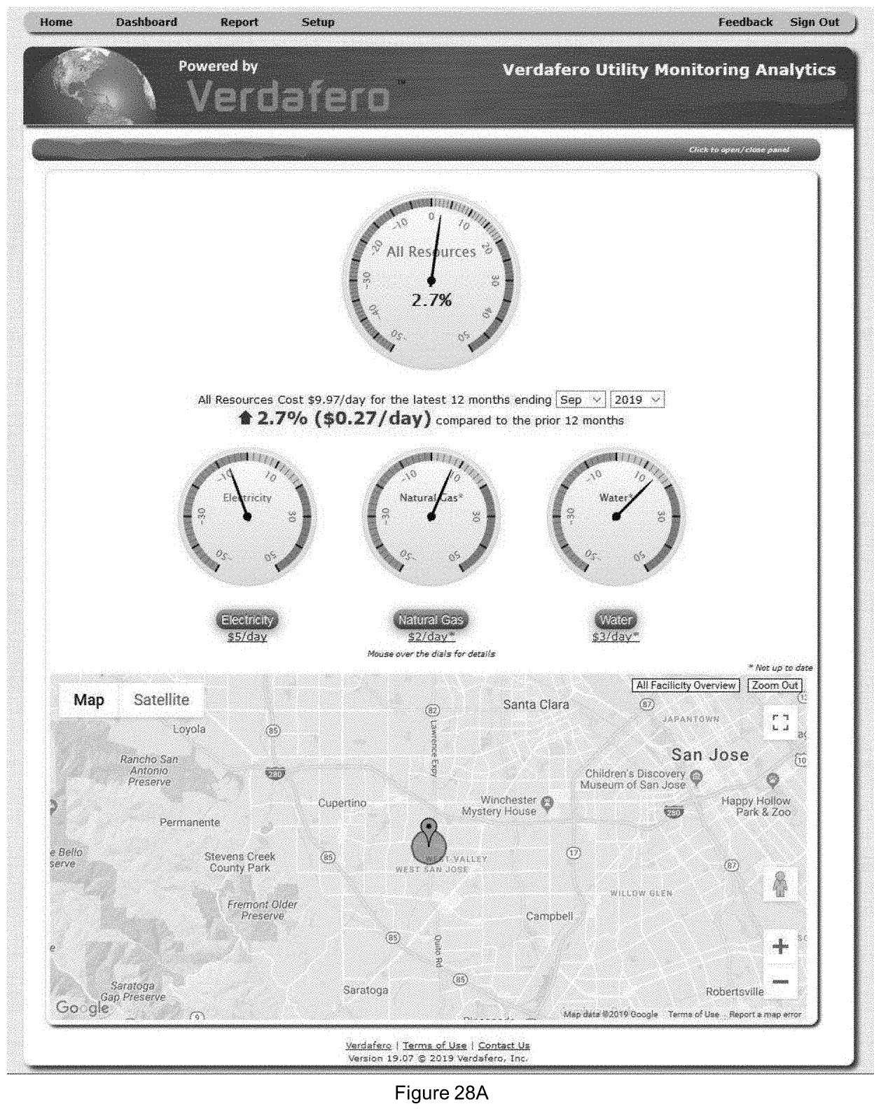

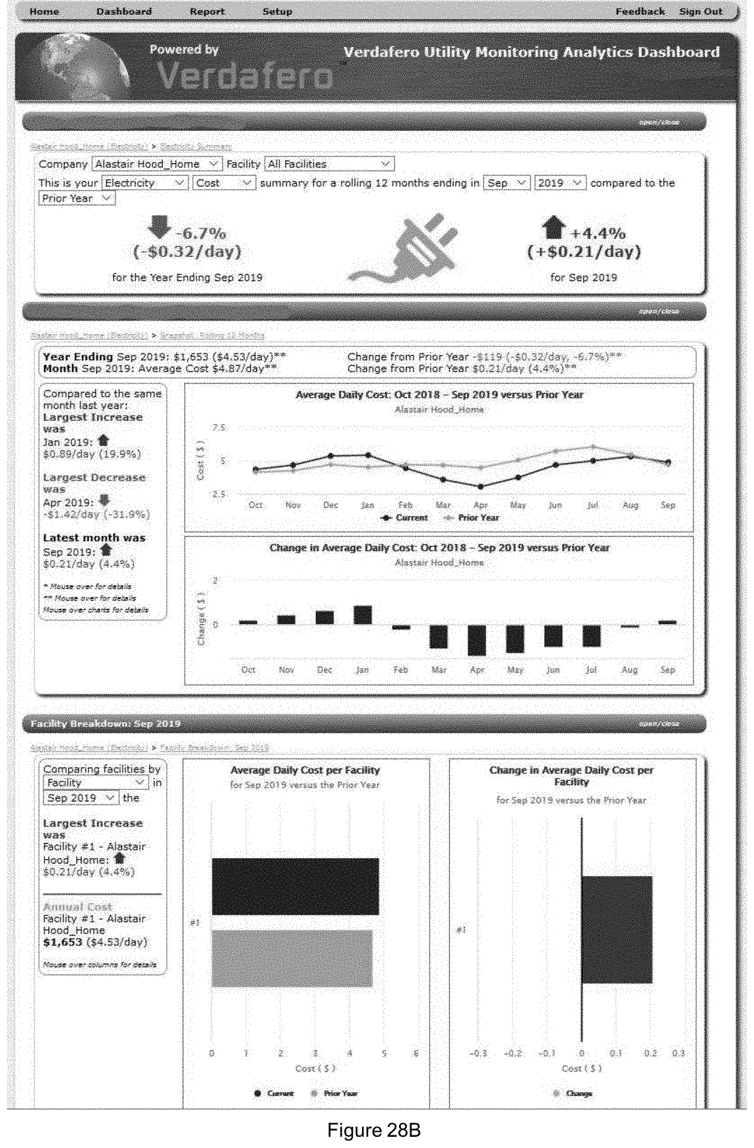

FIGS. 28A-28B illustrate an example of a company main utility monitoring dashboard user interface of the utility monitoring and analytics security management system. The user interface may include a summary portion 100 (that also allows the user to select a category to navigate to quickly), a utility monitoring summary portion 102 that has the key statistics for each utility monitoring category, a reports and certification portion 104 that displays the reports and certifications for the particular business whose user is viewing the user interface and a projects and planning portion 106 that displays the projects for the business. The company main utility monitoring dashboard user interface thus permits the user who is viewing the user interface to get a good overview of the utility monitoring progress of the business.

The system includes a multi-level UI approach with varying levels of interactivity between the user and the system. At the top level the user will interact with the system to visualize the portfolio level analysis. The user can then go to the next level of analysis and interact with the data analysis for a facility or group of facilities. The user can then go to the next level of analysis and interact with the data analysis for an individual utility meters within a facility. The user can then go to the next level of analysis and interact with the data analysis for an individual utility sub-meters under a meter within the facility. The user can then go to the next level of analysis and interact with the individual utility sensors under a sub-meter under a meter within a facility. At each level of analysis, the user can set appropriate alert thresholds or run rate, trending, deeper data normalization analysis if necessary.

Once the user has entered the basic information above, the user is presented with a sample performance dashboard that shows average estimated monthly utility usage and cost that is calculated based on: Industry and type of space, Square footage, Number of employees and Location.

The user is then asked questions to assess the amount their business has done to secure their utilities including actions taken to actively monitor their utilities, reduce utility usage. For each question, the user provides qualitative assessment of how much they have done (nothing, a little, some actions, a lot). The user is also asked questions about their existing physical infrastructure security systems, if any. Based on answers to questions about actions they've taken, user is presented with sample utility monitoring planning dashboard that has a set of projects in areas of electricity, water, waste, natural gas and transport are recommended based on: answers to qualitative assessment of actions already taken, industry and type of space.

The user is then asked questions to assess type of security reporting and tracking they have done of utility monitoring performance including: reporting to third party organizations, voluntarily or as part of security requirements. Based on answers to reporting questions, reports and certifications dashboard presented in which the user is shown certifications they might be eligible for based on industry and the user is shown additional information to be tracked to meet security standards for reporting or certification.

The user is also shown a complete dashboard with information about average company of their size, industry, space type with utility monitoring indicators they should be tracking, certifications and reports they could produce, security projects and planning they could undertake to improve utility security and specific next steps they should take based on their security goals including: reporting to stakeholders, reducing security risks/environmental impact and making a utility security monitoring plan.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A business utility monitoring and analytics security system, comprising:
one or more computing devices;
a utility monitoring and analytics security management unit that is capable of communicating with the one or more computing devices over a link;
a plurality of utility meters located adjacent a property that perform real time capturing of utility data for the property; and
the utility monitoring and analytics security management unit capturing property profile data of the property and receiving the utility data over the link from the plurality of utility meters, performing an analysis of the property profile data and utility data to benchmark the utility usage of the property, generating a utility security benchmark report for the property and delivering the utility security benchmark report to a user who manages the property.

2. The system of claim 1, wherein the utility usage of the property is one of a comparison of the utility usage of the property against a building of a similar size and use and a score of the utility usage of the property.

3. The system of claim 2, wherein a desired utility usage levels and a desired utility usage costs are set as thresholds for alerts usage, costs or rates cross these thresholds.

5. The system of claim 4, wherein the utility monitoring and analytics security management unit generates an alert report based on the thresholds.

6. The system of claim 1, wherein the utility monitoring and analytics security management unit generates an alert.

7. The system of claim 6, wherein a set of recommended best practices is a cause of the alert.

8. The system of claim 6, wherein the utility monitoring and analytics security management unit generates a set of actions to verify the cause of the alert.

9. The system of claim 6 further comprising a marketplace for vendors to aid the property user with a resolution of the utility alert.

10. The system of claim 1, wherein the utility monitoring and analytics security management unit is one of one or more server computers, a standalone computer, a mainframe and a downloadable application that is downloaded to the computing device.

11. The system of claim 10, wherein each computing device is one of a desktop computer, a laptop computer, a smartphone and a terminal computer.

12. The system of claim 11, wherein each computing device has a browser application.

13. The system of claim 11, wherein each computing device further comprises a cloud-based application that interacts with the utility monitoring and analytics security management unit.

14. A computer implemented property utility monitoring and analytics method using one or more computing devices and a utility monitoring and analytics security management unit that is capable of communicating with the one or more computing devices over a link, the method comprising:
performing real-time capturing, by plurality of utility meters located adjacent a property, capturing of utility data for the property;
capturing, by a utility monitoring and analytics security management unit, property profile data of the property;
receiving, by a utility monitoring and analytics security management unit, the utility data over the link from the plurality of utility meters;
performing an analysis of the property profile data and utility data to benchmark the utility usage of the property; and
generating a utility security benchmark report for the property and delivering the utility security benchmark report to a user who manages the property.

15. The method of claim 14 further comprising generating a set of security related utility alerts and reports based one or more user threshold values.

16. The method of claim 15 further comprising generating one or more recommendations about the utility usage and generating a set of recommended next steps for the recommendations including prioritization of the recommendations.

17. The method of claim 16, wherein the set of recommended next steps are one of a list of recommended next steps in a security area and a link to a vendor for the recommended solution.

18. The method of claim 14 further comprising generating, by the utility monitoring and analytics security management unit, a report.

19. The method of claim 18, wherein the report is one of a utility monitoring report, a utility analysis report, an abnormalities/potential security problems report, a property utility comparison report, a utility security monitoring certificate report, a property performance for insurance report, a local governmental building ordinance report, and a machine learning/AI detected fraudulent/suspicious activity report.
